(19) United States
(12) Patent Application Publication
(10) Pub. No.: US 2014/0372271 A1
(43) Pub. Date: Dec. 18, 2014

(54) Systems and Methods for Processing Cleared Loan Deliverable Futures Contract Data

(71) Applicant: Chicago Mercantile Exchange, Inc., Chicago, IL (US)

(72) Inventors: James Boudreault, Palatine, IL (US); Timothy Elliott, Evanston, IL (US); John Nyhoff, Darien, IL (US); John Labuszewski, Westmont, IL (US); Frederick Sturm, Chicago, IL (US)

(21) Appl. No.: 13/916,268

(22) Filed: Jun. 12, 2013

(51) Int. Cl. G06Q 40/00

(52) U.S. Cl. CPC G06Q 40/04
USPC 705/37

(57) ABSTRACT

An exchange computer system may perform operations associated with cleared loan deliverable futures contracts. A holder of a long interest in a cleared loan deliverable futures contract may agree to pay a principle amount, at a designated future settlement time, in return for subsequent repayment of that amount with interest. A holder of a short interest in a cleared loan deliverable futures contract may agree to borrow the principle amount at the settlement time and to repay that amount, with interest, at the subsequent time.

### BACKGROUND

Numerous types of financial products are traded through financial exchanges. From time to time, exchange participants may wish to access funds on a short term basis. In some cases, exchange participants may have funds available and be willing to provide access to those funds to other participants. There remains a need for methods and systems that facilitate these types of transactions between entities that transact business through a financial exchange.

### SUMMARY

This Summary is provided to introduce a selection of concepts in a simplified form that are further described below in the Detailed Description. This Summary is not intended to identify key or essential features of the invention.

In at least some embodiments, an exchange computer system may receive data identifying a type of cleared loan deliverable futures contract, a first party, a second party, and a contract price. As a result of the received data, the exchange computer system may store position data. The position data may indicate creation of a first cleared loan deliverable futures contract of the identified type, the first party as a holder of a long position in the first cleared loan deliverable futures contract, creation of a second cleared loan deliverable futures contract of the identified type, and the second party as a holder of a short position in the second cleared loan deliverable futures contract. The exchange computer system may determine, at or after a settlement time, whether the first party has transferred funds in an amount of a loan value to a clearinghouse. The exchange computer system may cause, at or after the settlement time and independent of the determination of whether the first party has transferred funds, transfer of funds in an amount of the loan value to the second party from the clearinghouse. The exchange computer system may also determine, at or after a repayment time, whether the second party has transferred funds to the clearinghouse in an amount of the loan value and a loan interest amount. The loan interest amount may be based on the contract price and the loan value. The exchange computer system may also cause, at or after the repayment time and independent of the determination of whether the second party has transferred funds to the clearinghouse, transfer of funds in an amount of the loan value and the loan interest amount to the first party from the clearinghouse.

Additional embodiments are described herein. Embodiments include, without limitation, methods for creating, administering, monitoring and/or otherwise processing data associated with cleared loan deliverable futures contracts, computer systems configured to perform such methods, and computer-readable media storing instructions that, when executed, cause a computer system to perform such methods.

### BRIEF DESCRIPTION OF THE DRAWINGS

Some embodiments are illustrated by way of example, and not by way of limitation, in the figures of the accompanying drawings and in which like reference numerals refer to similar elements.

FIG. 1 shows an exemplary trading network environment for implementing systems and methods according to at least some embodiments.

FIGS. 2A through 2G2 are diagrams illustrating operations performed in connection with cleared loan deliverable futures contracts (CLFDCs) according to some embodiments.

FIGS. 3A through 3C are a flow chart showing operations performed by an exchange computer system in connection with CLDFCs according to at least some embodiments.

### DETAILED DESCRIPTION

In the following description of various embodiments, reference is made to the accompanying drawings, which form a part hereof, and in which various embodiments are shown by way of illustration. It is to be understood that there are other embodiments and that structural and functional modifications may be made. Embodiments of the present invention may take physical form in certain parts and steps, examples of which will be described in detail in the following description and illustrated in the accompanying drawings that form a part hereof.

Various embodiments may comprise a method, a computer system, and/or a computer program product. Accordingly, one or more aspects of one or more of such embodiments may take the form of an entirely hardware embodiment, an entirely software embodiment and/or an embodiment combining software and hardware aspects. Furthermore, such aspects may take the form of a computer program product stored by one or more non-transitory computer-readable storage media having computer-readable program code, or instructions, embodied in or on the storage media. The term “computer-readable medium” or “computer-readable storage medium” as used herein includes not only a single medium or single type of medium, but also a combination of one or more media and/or types of media. Such a non-transitory computer-readable medium may store computer-readable instructions (e.g., software) and/or computer-readable data (i.e., information that may or may not be executable). Any suitable computer readable media may be utilized, including various types of non-transitory computer readable storage media such as hard disks, CD-ROMs, optical storage devices, magnetic storage devices, FLASH memory and/or any combination thereof. The term “computer-readable medium” or “computer-readable storage medium” could also include an integrated circuit or other device having hard-coded instructions (e.g., logic gates) that configure the device to perform one or more operations.

Aspects of method steps described in connection with one or more embodiments may be executed by one or more processors associated with a computer system (such as exchange computer system 100 and/or other computers described below). As used herein, a “computer system” could be a single computer or could comprise multiple computers. When a computer system comprising multiple computers performs a method, various steps could be performed by different ones of those multiple computers. Processors of a computer system may execute computer-executable instructions stored on non-transitory computer-readable media. Embodiments may also be practiced in a computer system forming a distributed computing environment, with tasks performed by remote processing devices that are linked through a communications network. In a distributed computing environment, program modules may be located in both local and remote computer storage media including memory storage devices.

### Exemplary Operating Environment

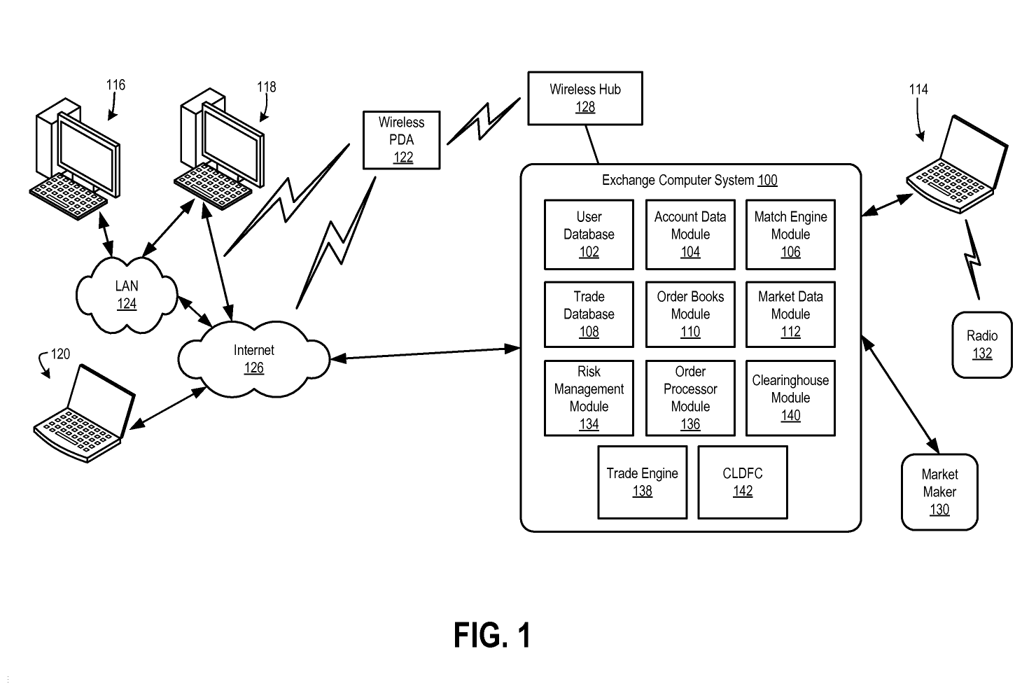

Aspects of at least some embodiments can be implemented with computer systems and computer networks that allow users to communicate trading information. An exemplary trading network environment for implementing systems and methods according to at least some embodiments is shown in FIG. 1. The implemented systems and methods can include systems and methods, such as are described herein, that facilitate data processing and other activities associated with cleared loan deliverable futures contracts.

Computer system 100 can be operated by a financial product exchange and configured to perform operations of the exchange for, e.g., trading and otherwise processing various financial products. Financial products of the exchange may include, without limitation, futures contracts, options on futures contracts, and other types of derivative contracts. Financial products traded or otherwise processed by the exchange may also include over-the-counter (OTC) products such as OTC forwards, OTC options, etc. In at least some embodiments, and as explained in more detail below, financial products traded and/or otherwise processed through exchange computer system 100 include cleared loan deliverable futures contracts.

Computer system 100 receives orders for financial products, matches orders to execute trades, transmits market data related to orders and trades to users, and performs other operations associated with a financial product exchange. Exchange computer system 100 may be implemented with one or more mainframe, desktop or other computers. In one embodiment, a computer device uses a 64-bit processor. A user database 102 includes information identifying traders and other users of exchange computer system 100. Data may include user names and passwords. An account data module 104 may process account information that may be used during trades. A match engine module 106 is included to match prices and other parameters of bid and offer orders. Match engine module 106 may be implemented with software that executes one or more algorithms for matching bids and offers.

A trade database 108 may be included to store information identifying trades and descriptions of trades. In particular, a trade database may store information identifying the time that a trade took place and the contract price. An order book module 110 may be included to store prices and other data for bid and offer orders, and/or to compute (or otherwise determine) current bid and offer prices. A market data module 112 may be included to collect market data, e.g., data regarding current bids and offers for futures contracts, futures contract options and other derivative products. Module 112 may also prepare the collected market data for transmission to users. A risk management module 134 may be included to compute and determine a user's risk utilization in relation to the user's defined risk thresholds. An order processor module 136 may be included to decompose delta based and bulk order types for further processing by order book module 110 and match engine module 106.

A clearinghouse module 140 may be included as part of exchange computer system 100 and configured to carry out operations of a clearinghouse of the exchange that operates computer system 100. Module 140 may receive data from and/or transmit data to trade database 108 and/or other modules of computer system 100 regarding trades of futures contracts, forward contracts, and other financial products traded through the exchange that operates system 100. Clearinghouse module 140 may facilitate the financial product exchange (or a clearinghouse of the exchange) acting as one of the parties to every traded contract or other product. For example, computer system 100 may match an offer by party A to sell a futures contract with a bid by party B to purchase a like futures contract. Module 140 may then create a first futures contract between party A and the exchange clearinghouse and a second futures contract between the exchange clearinghouse and party B. As another example, module 140 may maintain margin data with regard to clearing members and/or trading customers. As part of such margin-related operations, module 140 may store and maintain data regarding the values of various contracts and other instruments, determine mark-to-market and final settlement amounts, confirm receipt and/or payment of amounts due from margin accounts, confirm satisfaction of delivery and other final settlement obligations, etc.

A cleared loan deliverable futures contract (CLDFC) module 142 may be included as part of exchange computer system 100 and configured to carry out operations associated with creation and processing of cleared loan deliverable futures contracts. Such operations are described below in conjunction with subsequent drawing figures. As also discussed below, operations associated with cleared loan deliverable futures contracts may also and/or alternatively be performed by clearinghouse module 140.

Each of modules 102 through 142 could be implemented as separate software components executing within a single computer, separate hardware components (e.g., dedicated hardware devices) in a single computer, separate computers in a networked computer system, or any combination thereof (e.g., different computers in a networked system may execute software modules corresponding more than one of modules 102-142). When one or more of modules 102 through 142 are implemented as separate computers in a networked environment, those computers may be part of a local area network, a wide area network, and/or multiple interconnected local and/or wide area networks.

Exchange computer system 100 may also communicate in a variety of ways with devices that may be logically distinct from computer system 100. For example, computer device 114 is shown directly connected to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124 and may communicate with exchange computer system 100 via LAN 124. LAN 124 may implement one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics, radio links or other media.

A wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet. Computers 116, 118 and 120 may communicate with each other via the Internet 126 and/or LAN 124.

One or more market makers 130 may maintain a market by providing constant bid and offer prices for a derivative or security to exchange computer system 100. Exchange computer system 100 may also include trade engine 138. Trade engine 138 may, e.g., receive incoming communications from various channel partners and route those communications to one or more other modules of exchange computer system 100.

One skilled in the art will appreciate that numerous additional computers and systems may be coupled to exchange computer system 100. Such computers and systems may include, without limitation, additional clearing systems (e.g., computer systems of clearing member firms), regulatory systems and fee systems.

The operations of computer devices and systems shown in FIG. 1 may be controlled by computer-executable instructions stored on non-transitory computer-readable media. For example, computer device 116 may include computer-executable instructions for receiving market data from exchange computer system 100 and displaying that information to a user. As another example, cleared loan deliverable futures contract module 142 and/or other modules of exchange computer system 100 may include computer-executable instructions for performing herein-described operations associated with creation and processing of cleared loan deliverable futures contracts.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

### Exemplary Embodiments

In at least some embodiments, exchange computer system 100 (or “computer system 100”) receives, stores, generates, calculates and/or otherwise processes data so as to facilitate trading, execution, performance, management, monitoring and/or other activities associated with numerous types of financial products. Those products may include cleared loan deliverable futures contracts. For convenience, the acronym CLDFC is used herein as a shorthand reference to “cleared loan deliverable futures contract,” with “CLDFCs” indicating multiple cleared loan deliverable futures contracts.

“Futures contract” is a generic term for certain types of financial products. Futures contracts may be standardized according to a contract type established by an exchange. Among other things, the contract type may specify a particular subject matter, or “underlying,” for a category of futures contracts. As but one example, an underlying may be an agricultural or other type commodity. In such a case, the contract type may further specify delivery of a predefined amount of that commodity at a predefined future date. As yet another example, the underlying may be a currency, a market index, an interest rate or other economic subject matter. In such a case, the contract type may further specify payment on a predefined date of an amount computed from the value of the underlying on some future date.

There are two counterparties to a futures contract. A long counterparty (or “long”) usually refers to a futures contract party holding a long position. In a conventional futures contract, a long agrees to pay a contract price in return for some deliverable based on the underlying contract subject matter. That deliverable might be physical delivery of a contract commodity on a future date, payment on a future date based on a future value of an underlying, etc. A short counterparty (or “short”) usually refers to a futures contract party holding a short position. A short to a conventional futures contract agrees to receive the contract price at the predefined future date in return for the deliverable based on the underlying.

For each multi-laterally traded conventional futures contract, there is a long counterparty and a short counterparty. Generally, however, either the long or the short of each such contract is an exchange or clearinghouse. For example, a first counterparty may offer to sell a particular type of futures contract through an exchange. After the exchange publishes that offer, a second counterparty may purchase a futures contract of that type through the exchange at the offered price. The exchange then establishes a first contract in which the first counterparty is the short and the exchange clearinghouse is the long, and an offsetting second contract in which the second counterparty is the long and the exchange clearinghouse is the short, with the contract price of the first and second contracts being the same.

A CLDFC differs from conventional futures contracts in several ways. The underlying for a CLDFC is a loan processed through a clearinghouse. A holder of a long interest in a CLDFC agrees to pay a principle amount, at a designated settlement time for the CLDFC, in return for subsequent repayment of that amount with interest. A holder of a short interest in a CLDFC agrees to obtain the principle amount at the CLDFC settlement time and to repay that amount, with interest, at the subsequent time. The short interest holder may also agree to provide collateral, as discussed below. The principal amount, settlement time, repayment time, required collateral (if the underlying is secured) and other requirements for the transaction may be set forth in a CLDFC type definition established by the exchange and may not be subject to negotiation. In at least some embodiments, only the interest rate for the underlying transaction is negotiable.

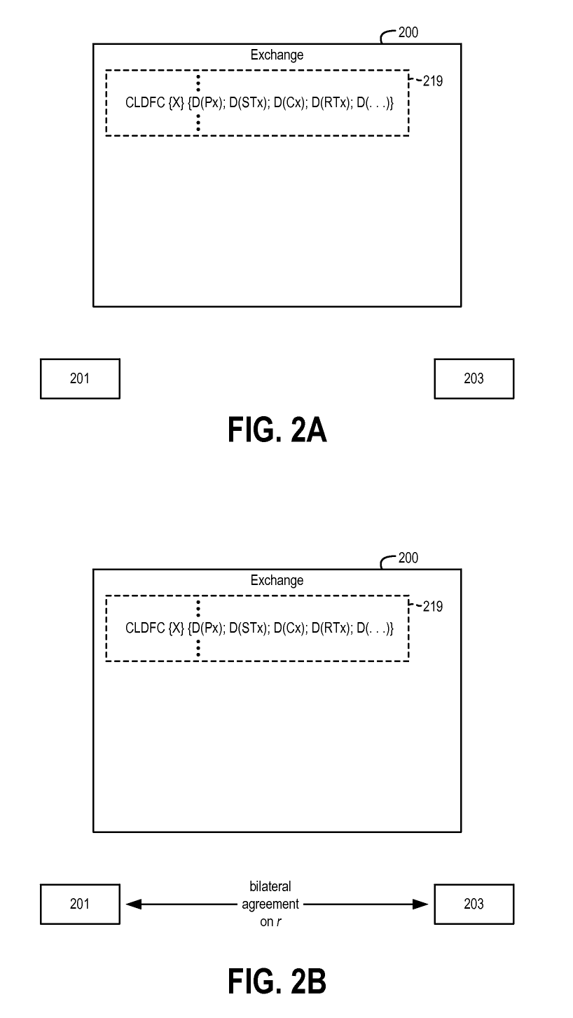

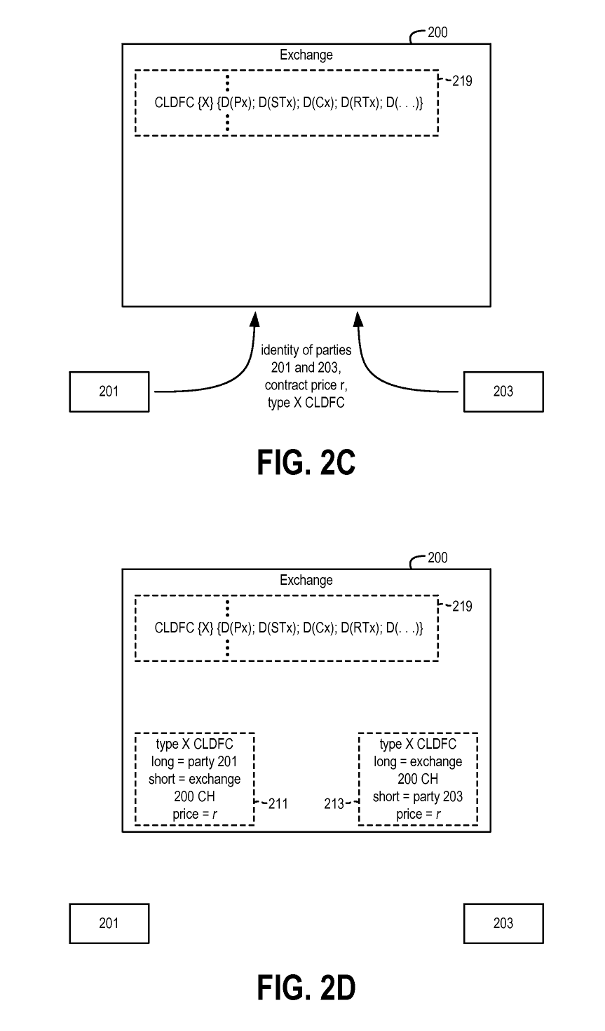

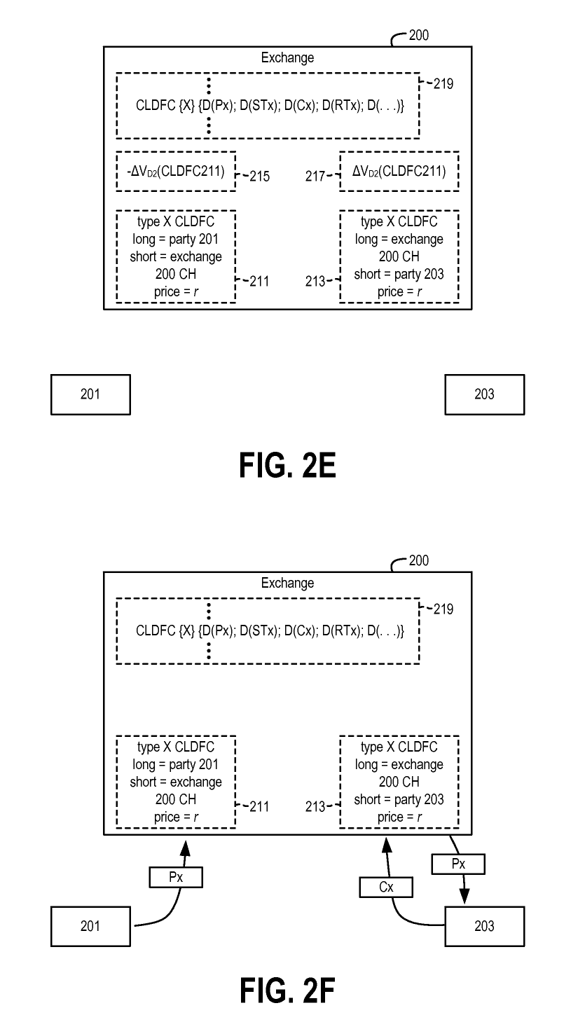

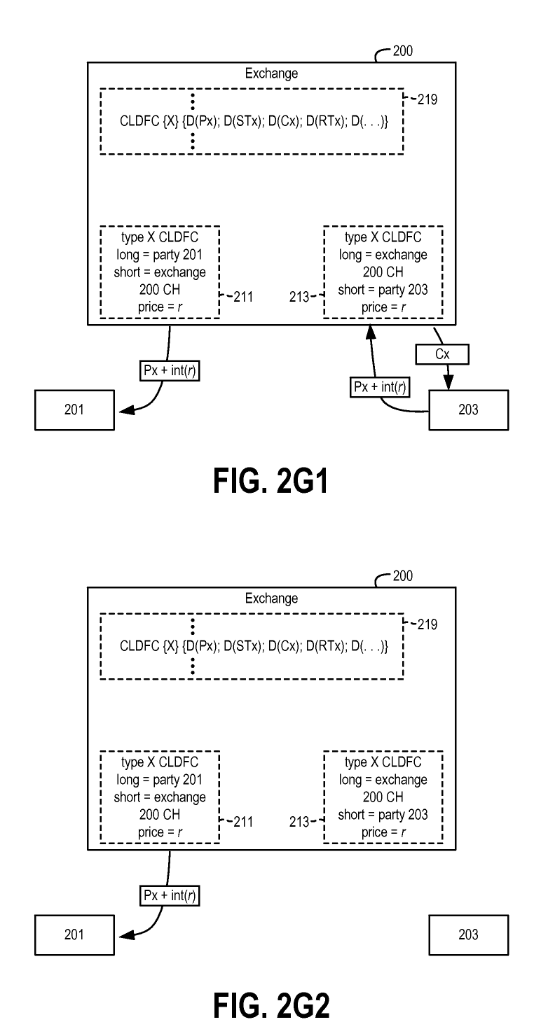

FIGS. 2A-2G2 are diagrams illustrating operations performed in connection with CLFDCs according to at least some embodiments. FIG. 2A shows a box representing an exchange 200 that operates computer system 100 of FIG. 1. As indicated in FIG. 2A, exchange 200 has stored data in a database 219 that defines a type “X” CLDFC. Under an X type CLDFC, a long agrees to loan a principal amount Px at a settlement time STx. A short under an X type CLDFC agrees to accept a loan of Px at STx and to provide collateral Cx as defined by the exchange. A short further agrees to repay Px with interest at a repayment time RTx. The type definition for an “X” CLDFC is indicated schematically in FIG. 2A as a database 219 entry in the form “CLDFC {X} {D(Px);D(STx);D(Cx);D(RTx);D( . . . )}”. The definitional parameters D(Px) may define a value, in a specific quantity of dollars or of other type of currency, for the principal amount of loans underlying individual type X CLDFCs. The definitional parameters D(STx) may define the settlement time, for individual type X CLDFCs, as a specific day and time by which initial loan and collateral obligations must be fulfilled or as a specific date and/or time range within which initial loan and collateral obligations must be fulfilled. In some embodiments, the D(STx) parameters may specify a time as a relative value derived from the date on which a type X CLDFC is entered.

The definitional parameters D(Cx) may define whether collateral is required for individual type X CLDFCs, and if so, what collateral is acceptable. The D(Cx) parameters may also define a “haircut” that will be applied, as described more fully below. The definitional parameters D(RTx) may define the repayment times, for individual type X CLDFCs, as a specific day and time by which final loan and collateral obligations must be fulfilled or as a specific date and/or time range within which final loan and collateral obligations must be fulfilled. As with D(STx,) the D(RTx) parameters may specify a time as a relative value derived from the date on which a type X CLDFC is entered. The definitional parameters D( . . . ) generally represent other parameters that define type X CLDFCs. Among other attributes, such parameters may specify how loan interest is computed for an underlying loan (e.g., based on a 360 day year).

The vertical ellipses in FIG. 2A indicate that exchange 200 may also define one or more other additional types of CLDFCs. As indicated above, data corresponding to the X CLDFC type definition and to other CLDFC type definitions may be stored in one or more databases 219 in (or accessible by) computer system 100. Such databases could be maintained, e.g., as part of CLDFC module 142.

Party 201 is an entity wishing to take a long position in a type X CLDFC. Party 203 is an entity wishing to take a short position in a type X CLDFC. Each of parties 201 and 203 may correspond to a computer or computer system that is logically distinct from computer system 100 (e.g., computers 116 and 120 of FIG. 1). Throughout the following description, it is to be understood that implied or express reference to communications to or from parties 201 and 203 refers to communications to or from computers corresponding to parties 201 and 203.

In FIG. 2B, parties 201 and 203 bilaterally negotiate and establish a contract price r, where r is the interest rate that will apply to the loan underlying a type X CLDFC. In other embodiments, and as described in more detail below, CLDFCs may be multilaterally traded through an exchange by submission of offers and bids to the exchange. In some such other embodiments, a CLDFC price is established by the exchange based on matching of offers and bids.

In at least some embodiments, interest rates for loans underlying CLDFCs defined by exchange 200 are quoted as 100 minus the interest rate in minimum increments of one quarter of a basis point. Using this convention, one quarter basis point corresponds to 0.000025%. A rate of 3.7650%, for example, would be quoted as 96.235. As another example, a rate of 3.7675% would be quoted as 96.2325.

In FIG. 2C, parties 201 and 203 transfer data to computer system 100 of exchange 200. The data identifies parties 201 and 203, indicates that parties 201 and 203 have agreed to enter into a type X CLDFC, and identifies the rate r as the contract price. Although FIG. 2C shows exchange 200 receiving data from both party 201 and party 203, this need not be the case. In some embodiments, for example, one of parties 201 and 203 may transmit data on behalf of both parties.

As a result receiving the data from parties 201 and 203 in FIG. 2C, and as shown in FIG. 2D, two separate type X CLDFCs are created. A first type X CLDFC 211 is created, between party 201 as the long and a clearinghouse of exchange 200 as the short, with a contract price/loan rate of r. A second type X CLFDC 213 is created, between party 203 as the short and the exchange 200 clearinghouse as the long, and also having a contract price/loan rate of r. Computer system 100 may store data for CLDFCs 211 and 213 in one or more databases (e.g., a database forming a part of module 142). The stored data for each of CLDFCs 211 and 213 may indicate the type of CLDFC, identities of the counterparties (e.g., the identity of party 201 for CLDFC 211 and the identity of party 203 for CLDFC 213), the contract price r, and other information.

To the clearinghouse, CLDFCs 211 and 213 are offsetting. Assuming that parties 201 and 203 fulfill their contractual obligations, the net effect of CLDFCs 211 and 213 to the exchange 200 clearinghouse is a wash. To party 201, satisfaction of short obligations under CLDFC 211 by the exchange 200 clearinghouse is equivalent to satisfaction of such obligations by party 203. To party 203, satisfaction of long obligations under CLDFC 213 by the exchange 200 clearinghouse is similarly equivalent to satisfaction of such obligations by party 201. However, parties 201 and 203 benefit because the clearinghouse of exchange 200 assumes the risk of counterparty default.

CLDFCs may also be marked to market in a manner similar to other futures contracts. For example, assume that parties 201 and 203 respectively entered into CLDFCs 211 and 213 on day D1. Further assume that, on trading day D2 which is after D1 and prior to STx, the closing price for other type X CLDFCs is r+Δr. If Δr is positive, this results in a decrease in the value of CLDFC 211 to party 201 and an increase in the value of CLDFC 213 to party 203. The decreased value to party 201 and the increased value to party 203 would both correspond to Δr and may be equal to Δr*Px*(LT/360), where “LT” is the number of days in the term of the loan (e.g., the number of days between STx and RTx).

This change in value can be exemplified as follows. If party 201 wishes on day D2 to eliminate its position in CLDFC 211, it must either find another party to assume its obligations under CLDFC 211 or obtain an offsetting short position in another type X CLDFC. Because the available interest earnable by longs of type X CLDFCs has risen by Δr on day D2, a third party would likely require an additional payment on day D2 before assuming the long obligations under CLDFC 211. If party 201 wishes to obtain an offsetting short position in another type X CLDFC on day D2, party 201 must do so at a contract price of r+Δr. At RTx for CLDFC 211 and for that offsetting short position, party 201 would receive interest at rate r but would also pay interest at a higher rate of r+Δr. A converse situation would exist for party 203. If party 203 wishes on day D2 to eliminate its position in CLDFC 213, it must either find another party to assume its obligations under CLDFC 213 or obtain an offsetting long position in another type X CLDFC. In the case of party 203, however, a third party assuming the short obligations under CLDFC 213 would likely pay a premium to party 203. If party 203 alternatively obtains an offsetting long position in another type X CLDFC, it may do so at a contract price of r+Δr. At RTx for CLDFC 213 and for that offsetting long position, party 201 would pay interest at rate r but would also receive interest at a higher rate of r+Δr.

As can be appreciated from the above, the circumstances are reversed if on day D2 the closing price for other type X CLDFCs is r+Δr, but Δr is negative. In such a scenario, the value of the long position of party 201 in CLDFC 211 increases by an amount corresponding to Δr. Similarly, the value of the short position of party 203 in CLDFC 213 decreases by an amount corresponding to Δr.

FIG. 2E illustrates mark-to-market for parties 201 and 203. FIG. 2E assumes that CLDFCs 211 and 213 were entered on day D1, that the mark-to-market calculations of FIG. 2E occur at the close of day D2, and that the closing price for other type X CLDFCs on day D2 has increased by Δr (i.e., the closing price is r+Δr, where Δr is positive). Computer system 100 (e.g., using modules 140 and 142) calculates the change in value of the long interest in CLDFC 211 and the change in value of the short interest in CLDFC 213. Computer system 100 then updates data for accounts of party 211 and party 213 to reflect the changes in the values of the parties' portfolios attributable to changes in the values of their respective positions in CLDFC 211 and CLDFC 213. A data record 215 (e.g., in module 140) corresponding to party 201 is updated to reflect a decrease in the value of the party 201 portfolio, attributable to CLDFC 211, of −ΔV_{D2}(CLDFC211). A data record 217 (e.g., also in module 140) corresponding to party 203 is updated to reflect an increase in the value of the party 203 portfolio, attributable to CLDFC 213, of ΔV_{D2}(CLDFC213). As indicated above, depending on the manner in which interest is computed under type X CLDFCs, −ΔV_{D2}(CLDFC211) may equal −Δr*Px*((D2−D1)/360) and ΔV_{D2}(CLDFC213) may equal Δr*Px*((D2−D1)/360). If the closing price on day D2 were instead r−Δr, record 215 would have instead been updated to reflect an increase in party 201 portfolio value attributable to CLDFC 211 and a decrease in party 203 portfolio value attributable to CLDFC 213. If there are additional trading days between D2 and STx, marking to market in a manner similar to that shown in FIG. 2E may be performed on additional days.

FIG. 2F illustrates events at settlement time STx for CLDFC 211 and CLDFC 213. Party 201 transfers funds in the amount of loan principal Px to the exchange 200 clearinghouse. Throughout the description herein, it is assumed that a transfer of funds or collateral between an external party (such as party 201 or party 203) and exchange 200 may be effected in various ways. Such ways include, without limitation, electronic transfer between an account external to exchange 200 (e.g., an external bank account) and an account maintained with exchange 200. In such a case, the transfer may be effected, at least in part, by storing data in computer system 100 reflecting the transfer to or from one or more accounts maintained with exchange 200. Ways of effecting transfer may also or alternatively include electronic transfer between accounts maintained with exchange 200, in which case computer system 100 may store data reflecting transfer to one or more accounts and from one or more accounts. Upon confirming the transfer of Px by party 201, exchange computer system 100 (e.g., module 140 and/or module 142) updates data records to indicate that transfer.

Party 203 transfers collateral Cx to the exchange 100 clearinghouse at time STx. Collateral Cx may be, e.g., a U.S. treasury note or other type of governmental security, a stock or other type of security in a private corporation, one or more interests in other financial products of exchange 100, and/or some other financial interest having a value. Collateral Cx might not be identical for all type X CLDFC contracts. For example, one type X CLDFC short may transfer a U.S. treasury obligation to the exchange 200 clearinghouse as collateral, while another type X CLDFX short might transfer a combination of U.S. treasury obligations and private securities to the exchange 200 clearinghouse as collateral.

In some embodiments, the D(Cx) parameters of the X CLDFC type definition specifies a value for Cx that includes (1) principal Px, (2) a quantity int(r) representing interest on the principal, over the term of the loan, at the rate agreed to by the parties, and (3) a “haircut” value H. Exchange 200 may define D(Cx) to include the additional value H so as to account for the risk associated with various types of collateral. As but one example, a 2% haircut may be imposed on governmental securities and a 50% haircut may be imposed on securities in private firms.

Upon confirming the transfer of collateral Cx by party 203, exchange computer system 100 (e.g., module 140 and/or module 142) updates data records to indicate that transfer. Exchange computer system 100 then effects a transfer of funds in the amount of the loan principal Px to party 203. This transfer is effected independently of whether party 201 transferred funds in the amount of Px to the exchange 200 clearinghouse.

FIG. 2G1 illustrates operations at repayment time RTx for CLDFC 211 and CLDFC 213 if party 203 fulfills its obligations. Party 203 transfers funds to the exchange 200 clearinghouse in the amount of Px+int(r). Upon confirming the transfer P(x)+int(r) from party 203, exchange computer system 100 (e.g., module 140 and/or module 142) updates data records to indicate that transfer. Exchange computer system 100 then effects transfer of collateral Cx back to party 203. At time RTx, computer system 100 of the exchange 200 clearinghouse effects a transfer of funds to party 201 in the amount of loan principal Px plus the interest on principal Px at rate r (“int(r)”). This transfer to party 201 is effected independently of whether party 203 has repaid the loan underlying CLDFC 213.

FIG. 2G2 illustrates operations at repayment time RTx for CLDFC 211 and CLDFC 213 if party 203 does not fulfill its obligations. As in the example of FIG. 2G1, computer system 100 of the exchange 200 clearinghouse transfers funds to party 201 in the amount of Px+int(r) without regard to whether party 203 has repaid the loan underlying CLDFC 213. In the example of FIG. 2G2, however, party 203 fails to transfer P(x)+int(r) to the exchange 200 clearinghouse. Accordingly, computer system 100 does not effect return of collateral Cx to party 203. Exchange 200 may then retain that collateral and liquidate it to satisfy some or all of the obligations of party 203 to repay P(x)+int(r).

In some embodiments, underlying loans for CLDFCs of a particular type may not be secured. In at least some such embodiments, the definitional parameters for that CLDFC type may indicate that no collateral is required. At a settlement time for such a CLDFC, a short position holder would not transfer collateral to the exchange 200 clearinghouse. At a loan repayment time for such a CLDFC, there would be no collateral for the exchange 200 clearinghouse to return to the short position holder.

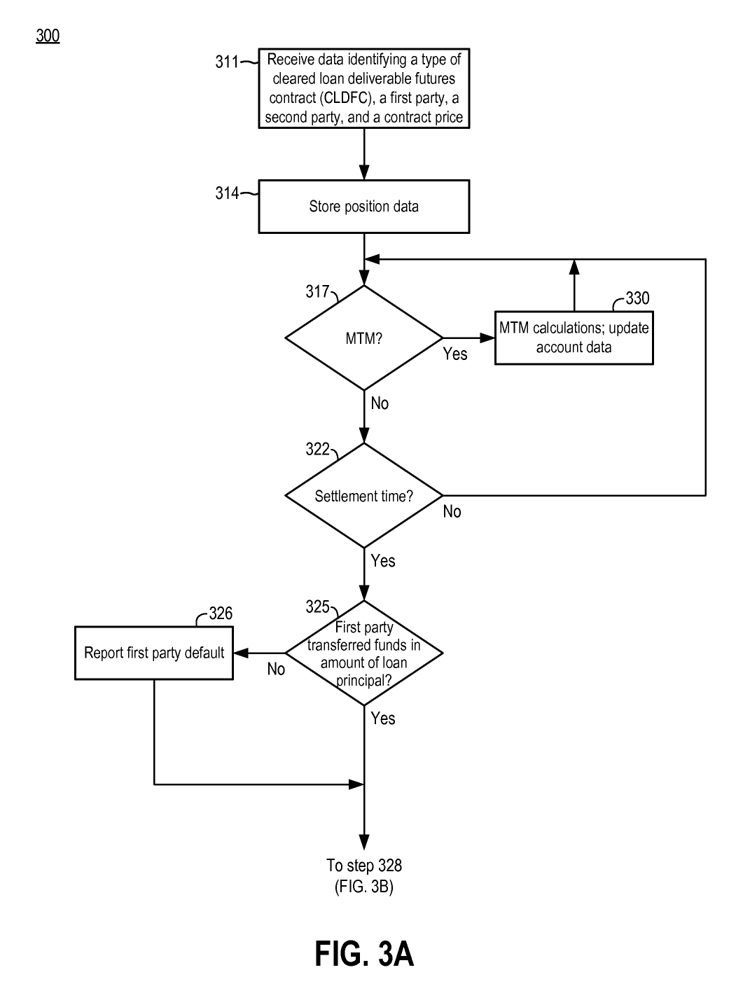

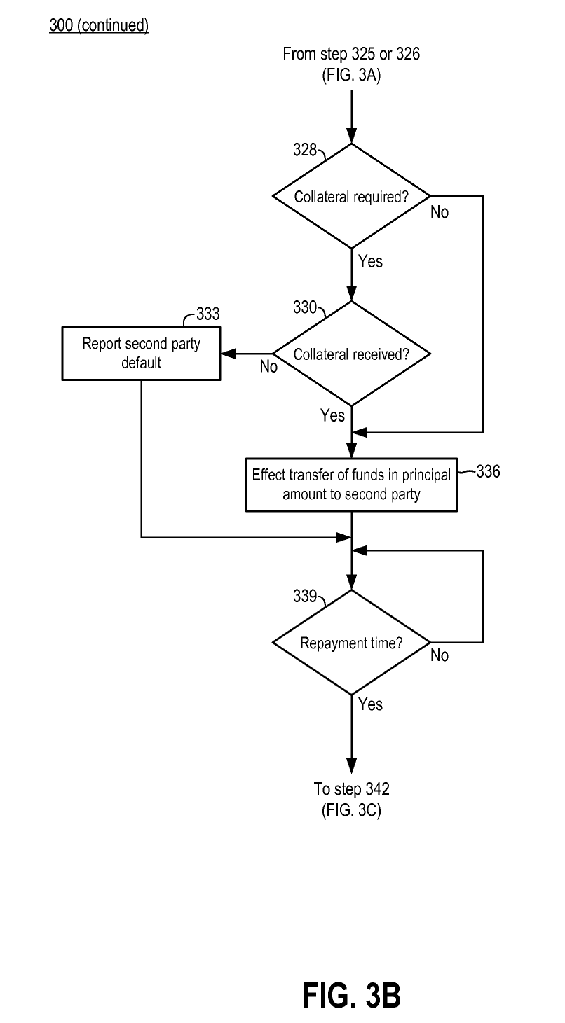

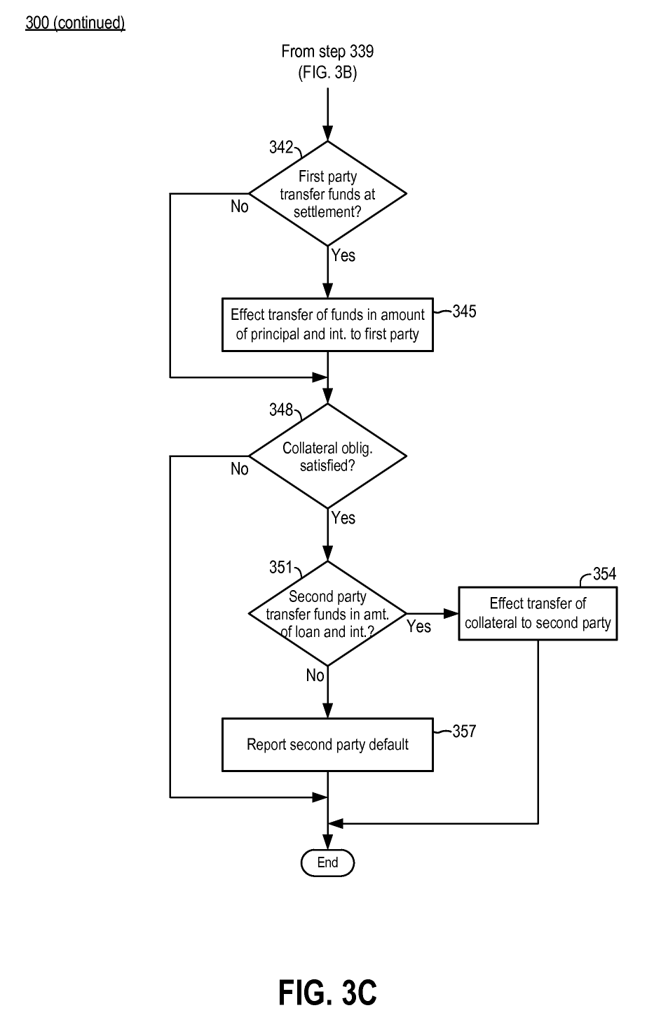

FIGS. 3A through 3C are a flow chart showing steps of a method 300, performed by exchange computer system 100 in at least some embodiments, in connection with data processing operations associated with creating, administering and/or otherwise processing a pair of CLDFCs such as CLDFC 211 and CLDFC 213 in the examples of FIGS. 2A-2G2. In some embodiments, the steps of method 300 may be performed by CLDFC module 142 and/or by clearinghouse module 140 of computer system 100. In other embodiments, some or all of the steps of method 300 may be performed by other modules of computer system 100. In still other embodiments, some or all steps of method 300 may be performed by one or more computer systems separate from computer system 100.

Method 300 is performed with regard to a single pair of CLDFCs. That pair includes a first CLDFC (e.g., CLDFC 211) between a long position holder (e.g., party 201 in FIGS. 2A-2G2) and the exchange 200 clearinghouse as the short. That pair further includes a second CLDFC (e.g., CLDFC 213) between a short position holder (e.g., party 203 in FIGS. 2A-2G2) and the exchange 200 clearinghouse as the long. Separate instances of method 200 may be performed for each of multiple pairs of such contracts.

In step 311 (FIG. 3A), computer system 100 receives data that identifies a type of CLDFC defined by exchange 200 (e.g., type X). For convenience, that CLDFC type will be called the “identified type” in the remainder of the discussion of method 300. The data received in step 311 also identifies a first party that will be a long position holder in a first CLDFC of the identified type, a second party that will be a short position holder in a second CLDFC of the identified type, and a contract price (e.g., r) for those two CLDFCs of the identified type. In embodiments where parties bilaterally negotiate the contract price and agree to enter CLDFCs, step 311 may comprise receiving data from one or both parties. In other embodiments, and as described below, step 311 may comprise receiving data from other modules of computer system 100 (e.g., from match engine module 100).

As a result of the data received in step 311, computer system 100 stores position data in step 314. Computer system 100 may store this data in one or more databases that are part of or otherwise accessible by computer system 100. The position data includes first data that indicates the creation of the first CLDFC of the pair. In particular, this first data indicates creation of a first CLDFC of the identified type between the first party as the first CLDFC long and the exchange 200 clearinghouse as the first CLDFC short. The first data further indicates the identity of the first party as the first CLDFC long position holder and the contract price as the price (loan rate) for the first CLDFC. The first data also indicates various parameters defined by exchange 200 for the identified CLDFC type. These parameters may include parameters defining an amount of principle (e.g., D(Px)) for an underlying loan, parameters defining a settlement time (e.g., D(STx)), parameters defining a repayment time (e.g., D(RTx)), and other parameters. The first data may indicate these parameters by pointing to type definition data for the identified CLDFC type (e.g., the type X definition data from the example of FIGS. 2A-2G2), by including copies of such definitional data, and/or in some other manner.

The position data also includes second data that indicates the creation of the second CLDFC of the pair. In particular, this data indicates creation of a second CLDFC of the identified type between the second party as the second CLDFC short and the exchange 200 clearinghouse as the second CLDFC long. The second data further indicates the identity of the second party as the second CLDFC short position holder and the contract price as the price (loan rate) for the second CLDFC. The second data also indicates various parameters defined by exchange 200 for the identified CLDFC type. These parameters may include parameters defining an amount of principle (e.g., D(Px)) for an underlying loan, parameters defining a settlement time (e.g., D(STx)), parameters defining whether collateral is required, and if required, allowed collateral, haircut values, etc. (e.g., D(Cx)), parameters defining a repayment time (e.g., D(RTx)), and other parameters. As with the first data, the second data may indicate these parameters by pointing to data defining the identified CLDFC type, by including copies of such definitional data, and/or in some other manner.

In step 317, computer system 100 determines if mark-to-market (MTM) operations are required for the first and second CLDFCs. In some embodiments, computer system 100 makes this determination by determining (i) if it is the close of a current trading day, (ii) if there are additional trading days for the identified type of CLDFC between the current day and the settlement time for the first and second CLDFCs, and (iii) if MTM operations for the current trading day have yet to be performed. If the answer to (i), (ii) and (iii) is yes, then MTM operations are required. If MTM operations are required, computer system 100 proceeds on the “yes” branch to step 320, performs MTM calculations, updates accounts of the first and second parties as required, and then returns to step 317. If computer system 100 determines at step 317 that MTM operations are not required, computer system 100 proceeds on the “no” branch to step 322.

In block 322, computer system 100 determines if settlement time (e.g., STx) for the first and second CLDFCs has arrived. If not (e.g., if there are non-trading days prior to the settlement time and it is one of those non-trading days, etc.), computer system 100 returns to step 317 on the “no” branch. If settlement time has arrived, computer system 100 proceeds to step 325.

In step 325, computer system 100 determines if the first party has transferred funds in the amount of the underlying loan principal (e.g., Px) to exchange 100. Computer system 100 may make this determination by comparing the position data with data indicating the occurrence or non-occurrence of the required transfer by or behalf of the first party. If it is determined that the first party has transferred funds in the amount of the underlying loan principal, computer system 100 stores data indicating the transfer (not shown) and proceeds on the “yes” branch to step 328 of FIG. 3B. If the first party does not transfer funds in the amount of the underlying loan principal, computer system 100 proceeds on the “no” branch to block 326 and performs additional steps to notify appropriate persons of a default by the first party. From step 326, computer system 100 proceeds to step 328.

Turning to FIG. 3B, computer system 100 determines in step 328 if the underlying loan is secured, i.e., if the short position holder in the second CLDFC is required to provide collateral (e.g., Cx). Computer system 100 may make this determination based, e.g., on the position data stored in step 314. If computer system 100 determines in step 328 that no collateral is required, method 300 proceeds directly to step 336 on the “no” branch from step 328.

If the underlying loan is secured, computer system 100 proceeds to step 330 and determines if the second party has transferred the required collateral to the exchange 200 clearinghouse. This determination may be based on a comparison of the position data stored in step 314 with data indicating the occurrence or non-occurrence of the collateral transfer. If the second party does not transfer the required collateral, computer system 100 proceeds to step 333 on the “no” branch. In step 333, computer system 100 performs additional steps to notify appropriate persons of a default by the second party. From step 333, computer system 100 bypasses step 336 and proceeds to step 339. If it is determined in step 330 that the second party has transferred the required collateral, computer system 100 proceeds on the “yes” branch to block 336. In block 336, computer system 100 effects transfer of funds to the second party in the amount of the loan principal (e.g., Px). From step 336, computer system 100 proceeds to step 339.

In step 339, computer system 100 determines, based on data stored in step 314, if repayment time (e.g., RTx) for the underlying loan has arrived. If not, computer system 100 proceeds on the “no” branch to repeat step 339. If so, computer system 100 proceeds in the “yes” branch to step 342.

Turning to FIG. 3C, computer system 100 determines in step 342 if the first party transferred the loan principal at settlement time (i.e., if the determination at step 325 was “yes”). If so, computer system 100 proceeds on the “yes” branch to step 345, where computer system 100 effects transfer of the loan principal and interest (e.g., Px+int(r)) to the first party. From step 345, computer system 100 proceeds to step 348. If computer system 100 determines in step 342 that the first party failed to transfer the loan principal at settlement time, computer system 100 proceeds on the “no” branch directly to step 348.

In step 348, computer system 100 determines if the second party complied with its collateral obligations, i.e., whether (i) no collateral was required (a “no” determination in step 328), or (ii) that required collateral was received (“yes” determinations in steps 328 and 330). If computer system 100 determines in step 348 that neither condition (i) nor condition (ii) is satisfied, computer system 100 proceeds directly to the end of method 300 along the “no” branch. If computer systems 100 determines in step 348 that either condition (i) or condition (ii) is satisfied, computer system 100 proceeds to step 351 on the “yes” branch and determines whether the second party has effected transfer to the exchange 200 clearinghouse of repayment of loan principal and payment of the required interest (e.g., Px+int(r)). If so, computer system 100 proceeds to step 354 and effects transfer of the collateral (i.e., the collateral for which receipt was confirmed in step 330) back to the second party. From step 354, method 300 ends. If it is determined in step 351 that the second party has not repaid the loan principal and also paid the required interest, computer system 100 proceeds to step 357 and performs additional steps to notify appropriate persons of a default by the second party. From step 357 method 300 ends.

Method 300 represents operations performed by computer system 100 according to some embodiments. In other embodiments, one or more steps may be modified and/or their order rearranged. Additional steps may also be added.

In some embodiments, the data received in step 311 of method 300 indicates that the first and second parties have bilaterally agreed to enter CLDFCs at a contract price negotiated by those parties. Examples of such embodiments include the examples of FIGS. 2A-2G2. In other embodiments, the data received in step 311 may indicate matching by computer system 100 of an offer submitted by the first party with a bid submitted by the second party.

In particular, and as previously indicated, in some embodiments CLDFCs may be multilaterally traded through an exchange by submission of offers and bids to the exchange. In some such other embodiments, a contract price is established by the exchange based on matching of offers and bids. In particular, a potential CLDFC long, i.e., a party wishing to take a long position in a CLDFC, may submit an offer to the exchange for a CLDFC. That offer may specify an offer price representing an interest rate the offeror will accept in return for paying the principle amount in accordance with standardized CLDFC terms. A potential CLDFC short, i.e., a party wishing to take a short position in a CLDFC, may submit a bid. That bid may specify a bid price representing an interest rate the bidder will pay in return for borrowing the principle amount in accordance with standardized CLDFC terms. The exchange may then match the bid and the offer and set a contract price based on the match. The exchange might match the offer to the bid because the offer and bid prices are the same. This need not be the case, however. For example, an offer may indicate the minimum acceptable interest rate for the offeror is P, and a bid may indicate that the maximum acceptable interest rate to the bidder is Q, where P<Q. However, the offeror would likely be willing to accept an interest rate higher than P and thus make more money. Similarly, the bidder would likely be willing to pay an interest rate less than Q so as to thus save money. If an offer and a bid are matched in this situation, rules of the exchange may dictate whether the matched price is P, Q or some amount between P and Q.

As with other types of futures contracts, offers and bids for CLDFCs may be matched anonymously in embodiments where an exchange performs such matching. In particular, an offeror submitting a CLDFC offer may never learn the identity of the bidder that submitted a CLDFC bid to which the offer is matched. The initial matching may be performed by the exchange based on separate inputs by the offeror and by the bidder. Once the offer and bid are matched, the exchange creates two separate offsetting contracts based on the match. A first CLFDC is created between the offeror (as the long) and the exchange clearinghouse (as the short) at the matched price. A second CLFDC is created between the bidder (as the short) and the exchange clearinghouse (as the long) at the same matched price.

In embodiments where an exchange matches CLDFC offers and bids, operations as described in connection with FIGS. 2D through 2G2 may still be performed. Similarly, an exchange may perform a method that is similar to method 300, with the exception that step 311 may comprise receipt of data from one or more sources within computer system 100 such as, e.g., match engine module 106.

Table 1 provides non-limiting examples of attributes of CLDFC types according to some embodiments.

TABLE 1

| | |
|---|---|
| Contract Size | Based on $1,000,000 (USD) Notional Value (NV) at origination |
| Quote | Quoted as 100 less interest rate (100-R) in minimum increments of |
| | one-quarter (1/4) basis point or 0.000025%. e.g., rates (R) of |
| | 3.7650%, 3.7675%, 3.7700%, 3.7725% translate into quotes of |
| | 96.235, 96.2325, 96.23, 96.2275 |
| Tick Value | One-quarter (1/4) basis point represents $0.0694 for a 1-day tenor |
| | loan (= 0.000025 × $1,000,000/360); $0.1389 for 2-days; $0..3472 |
| | for 3-days; $0.4861 for 7-days; $0.9722 for 14 days; $1.9444 for 28 |
| | days |
| Settlement (Delivery) | Cleared Loan Deliverable Futures Contracts (CLDFCs) may be |
| Dates | quoted for delivery on any exchange business day; upon delivery, |
| | CLDFCs booked to the accounts of longs (lenders upon delivery) |
| | and shorts (borrowers upon delivery) |
| Term of Underlying | Loans delivered vs. delivered CLDFCs with terms between |
| Loan | Settlement and Repayment Dates of overnight (O/N), 2 days, 3 |
| | days, 7 days, 14 days, 28 days; also, contracts with repayment dates |
| | corresponding to Treasury refunding dates; 1st and last business |
| | days of March quarterly cycle (March, June, Sep, Dec) |
| Delivery | Longs deliver $1 million to exchange clearinghouse on settlement |
| | date, passed to Short; shorts deliver collateral valued at $1 million + |
| | interest; transaction reversed on repayment date; clearinghouse |
| | defines acceptable Treasuries as collateral, possibly subject to a |
| | “haircut” reflective of risk |
| Interest Rate (Contract | Interest due on repayment date calculated as function of days until |
| Price) | maturity (d) and transacted interest rate (R): Interest = $1,000,000 × |
| | (d/360) × R |
| | e.g., if R = 3.765% and d = 7 days |
| | then interest = $732.08 = $1,000,000 × (7/360) × 0.03765 |
| Trading Hours | Privately transacted on bi-lateral basis between two eligible |
| | counterparties and subsequently novated to clearinghouse for |
| | administration |

### CONCLUSION

The foregoing description of embodiments has been presented for purposes of illustration and description. The foregoing description is not intended to be exhaustive or to limit embodiments to the precise form explicitly described or mentioned herein. Modifications and variations are possible in light of the above teachings or may be acquired from practice of various embodiments. For example, one of ordinary skill in the art will appreciate that some steps illustrated in the figures may be performed in other than the recited order, and that one or more steps illustrated may be optional in one or more embodiments. The embodiments discussed herein were chosen and described in order to explain the principles and the nature of various embodiments and their practical application to enable one skilled in the art to make and use these and other embodiments with various modifications as are suited to the particular use contemplated. Any and all permutations of features from above-described embodiments are the within the scope of the invention.

1. A method comprising:
(a) receiving, by an exchange computer system, data identifying a type of cleared loan deliverable futures contract, a first party, a second party, and a contract price;
(b) storing position data by the exchange computer system as a result of the data received in (a), wherein the position data indicates creation of a first cleared loan deliverable futures contract of the identified type, the first party as a holder of a long position in the first cleared loan deliverable futures contract, creation of a second cleared loan deliverable futures contract of the identified type, and the second party as a holder of a short position in the second cleared loan deliverable futures contract;
(c) determining, by the exchange computer system at or after a settlement time, whether the first party has transferred funds in an amount of a loan value to a clearinghouse;
(d) effecting, by the exchange computer system, at or after the settlement time and independent of the outcome of the determination of (c), transfer of funds in an amount of the loan value to the second party from the clearinghouse;
(e) determining, by the exchange computer system at or after a repayment time, whether the second party has transferred funds to the clearinghouse in an amount of the loan value and a loan interest amount, wherein the loan interest amount is based on the contract price and the loan value; and
(f) effecting, by the exchange computer system, at or after the repayment time, and independent of the outcome of the determination of (e), transfer of funds in an amount of the loan value and the loan interest amount to the first party from the clearinghouse.

2. The method of claim 1, wherein
the position data indicates the loan value, the contract price, the settlement time and the repayment time,
the exchange computer system performs the determination of (c) based on comparison of the position data with data regarding the occurrence or non-occurrence of a transfer associated with the first party, and
the exchange computer system performs the determination of (e) based on comparison of the position data with data regarding the occurrence or non-occurrence of a transfer associated with the second party.

3. The method of claim 1, wherein the position data includes data indicating collateral requirements, and further comprising:
determining, by the exchange computer system, whether the second party has transferred collateral to the clearinghouse that satisfies the collateral requirements.

4. The method of claim 3, wherein the determining whether the second party has transferred collateral occurs prior to (d), wherein (d) is performed based on a determination that the second party has transferred collateral to the clearinghouse that satisfies the collateral requirements, and further comprising:
effecting, by the exchange computer system and based on a determination in (e) that the second party has transferred funds to the clearinghouse in an amount of the loan value and the loan interest amount, transfer of the collateral from the clearinghouse to the second party.

5. The method of claim 1, further comprising:
performing, by the exchange computer system after (b) and prior to the settlement time, mark to market calculations based on a change in value of the long position in the first cleared loan deliverable futures contract and based on a change in value of the short position in the second cleared loan deliverable futures contract; and
storing, by the exchange computer system, data indicating adjustments to portfolio values based on the mark to market calculations.

6. The method of claim 1, wherein (a) comprises receiving data indicating bilateral negotiation by the first party and second party.

7. The method of claim 1, wherein (a) comprises receiving data indicating matching of an offer submitted by the first party and a bid submitted by the second party, and further comprising:
receiving, by the exchange computer system and prior to (a), the offer submitted by the first party and the bid submitted by the second party; and
anonymously matching, by the exchange computer system, the offer and the bid.

8. One or more non-transitory computer-readable media storing computer executable instructions that, when executed, cause a computer system to perform operations that include:
(a) receiving data identifying a type of cleared loan deliverable futures contract, a first party, a second party, and a contract price;
(b) storing position data as a result of the data received in (a), wherein the position data indicates creation of a first cleared loan deliverable futures contract of the identified type, the first party as a holder of a long position in the first cleared loan deliverable futures contract, creation of a second cleared loan deliverable futures contract of the identified type, and the second party as a holder of a short position in the second cleared loan deliverable futures contract;
(c) determining, at or after a settlement time, whether the first party has transferred funds in an amount of a loan value to a clearinghouse;
(d) effecting, at or after the settlement time and independent of the outcome of the determination of (c), transfer of funds in an amount of the loan value to the second party from the clearinghouse;
(e) determining, at or after a repayment time, whether the second party has transferred funds to the clearinghouse in an amount of the loan value and a loan interest amount, wherein the loan interest amount is based on the contract price and the loan value; and
(f) effecting, at or after the repayment time, and independent of the outcome of the determination of (e), transfer of funds in an amount of the loan value and the loan interest amount to the first party from the clearinghouse.

9. The one or more non-transitory computer-readable media of claim 8, wherein
the position data indicates the loan value, the contract price, the settlement time and the repayment time,
the determination of (c) is based on comparison of the position data with data regarding the occurrence or non-occurrence of a transfer associated with the first party, and
the determination of (e) is based on comparison of the position data with data regarding the occurrence or non-occurrence of a transfer associated with the second party.

10. The one or more non-transitory computer-readable media of claim 8, wherein the position data includes data indicating collateral requirements, and wherein the stored instructions further comprise instructions that, when executed, cause the computer system to perform operations that include:
determining whether the second party has transferred collateral to the clearinghouse that satisfies the collateral requirements.

11. The one or more non-transitory computer-readable media of claim 10, wherein the determining whether the second party has transferred collateral occurs prior to (d), wherein (d) is performed based on a determination that the second party has transferred collateral to the clearinghouse that satisfies the collateral requirements, and wherein the stored instructions further comprise instructions that, when executed, cause the computer system to perform operations that include:
effecting, based on a determination in (e) that the second party has transferred funds to the clearinghouse in an amount of the loan value and the loan interest amount, transfer of the collateral from the clearinghouse to the second party.

12. The one or more non-transitory computer-readable media of claim 8, wherein the stored instructions further comprise instructions that, when executed, cause the computer system to perform operations that include:
performing, after (b) and prior to the settlement time, mark to market calculations based on a change in value of the long position in the first cleared loan deliverable futures contract and based on a change in value of the short position in the second cleared loan deliverable futures contract; and
storing data indicating adjustments to portfolio values based on the mark to market calculations.

13. The one or more non-transitory computer-readable media of claim 8, wherein (a) comprises receiving data indicating bilateral negotiation by the first party and second party.

14. The one or more non-transitory computer-readable media of claim 8, wherein (a) comprises receiving data indicating matching of an offer submitted by the first party and a bid submitted by the second party, and wherein the stored instructions further comprise instructions that, when executed, cause the computer system to perform operations that include:
receiving, prior to (a), the offer submitted by the first party and the bid submitted by the second party; and
anonymously matching the offer and the bid.

15. A computer system comprising:
at least one processor; and
at least one non-transitory memory, wherein the at least one non-transitory memory stores instructions that, when executed, cause the computer system to perform operations that include
(a) receiving data identifying a type of cleared loan deliverable futures contract, a first party, a second party, and a contract price,
(b) storing position data as a result of the data received in (a), wherein the position data indicates creation of a first cleared loan deliverable futures contract of the identified type, the first party as a holder of a long position in the first cleared loan deliverable futures contract, creation of a second cleared loan deliverable futures contract of the identified type, and the second party as a holder of a short position in the second cleared loan deliverable futures contract,
(c) determining, at or after a settlement time, whether the first party has transferred funds in an amount of a loan value to a clearinghouse,
(d) effecting, at or after the settlement time and independent of the outcome of the determination of (c), transfer of funds in an amount of the loan value to the second party from the clearinghouse,
(e) determining, at or after a repayment time, whether the second party has transferred funds to the clearinghouse in an amount of the loan value and a loan interest amount, wherein the loan interest amount is based on the contract price and the loan value, and
(f) effecting, at or after the repayment time, and independent of the outcome of the determination of (e), transfer of funds in an amount of the loan value and the loan interest amount to the first party from the clearinghouse.

16. The computer system of claim 15, wherein
the position data indicates the loan value, the contract price, the settlement time and the repayment time,
the determination of (c) is based on comparison of the position data with data regarding the occurrence or non-occurrence of a transfer associated with the first party, and
the determination of (e) is based on comparison of the position data with data regarding the occurrence or non-occurrence of a transfer associated with the second party.

17. The computer system of claim 15, wherein the position data includes data indicating collateral requirements, and wherein the stored instructions further comprise instructions that, when executed, cause the computer system to perform operations that include
determining whether the second party has transferred collateral to the clearinghouse that satisfies the collateral requirements.

18. The computer system of claim 17, wherein the determining whether the second party has transferred collateral occurs prior to (d), wherein (d) is performed based on a determination that the second party has transferred collateral to the clearinghouse that satisfies the collateral requirements, and wherein the stored instructions further comprise instructions that, when executed, cause the computer system to perform operations that include
effecting, based on a determination in (e) that the second party has transferred funds to the clearinghouse in an amount of the loan value and the loan interest amount, transfer of the collateral from the clearinghouse to the second party.

19. The computer system of claim 15, wherein the stored instructions further comprise instructions that, when executed, cause the computer system to perform operations that include
performing, after (b) and prior to the settlement time, mark to market calculations based on a change in value of the long position in the first cleared loan deliverable futures contract and based on a change in value of the short position in the second cleared loan deliverable futures contract, and
storing data indicating adjustments to portfolio values based on the mark to market calculations.

20. The computer system of claim 15, wherein (a) comprises receiving data indicating bilateral negotiation by the first party and second party.

21. The computer system of claim 15, wherein (a) comprises receiving data indicating matching of an offer submitted by the first party and a bid submitted by the second party, and wherein the stored instructions further comprise instructions that, when executed, cause the computer system to perform operations that include
receiving, prior to (a), the offer submitted by the first party and the bid submitted by the second party, and
anonymously matching the offer and the bid.
